(19) United States
(12) Patent Application Publication
(10) Pub. No.: US 2018/0162255 A1
(43) Pub. Date: Jun. 14, 2018

(54) CARPET IN A VEHICLE AND METHOD TO MANUFACTURE THE SAME

(71) Applicant: Ford Global Technologies LLC, Dearborn, MI (US)

(72) Inventors: Hogan Jiang, Nanjing (CN); Kevin Shen, Nanjing (CN); Fernando Zhao, Nanjing (CN); Xuezhi Jin, Nanjing (CN)

(21) Appl. No.: 15/835,053

(22) Filed: Dec. 7, 2017

(30) Foreign Application Priority Data
Dec. 14, 2016 (CN) 201611150260.2

(51) Int. Cl. B60N 3/04

(52) U.S. Cl. CPC B60N 3/048

(57) ABSTRACT

A carpet in a vehicle is provided. The carped includes a polypropylene layer, a felt layer, and at least one first fastener disposed between the PP layer and the felt layer. The first fastener has an upper half and a lower half inserted into a portion of the PP layer and a portion of the felt layer, respectively, to connect the PP layer and the felt layer.

### RELATED APPLICATION

This application claims the benefit of Chinese Patent Application No. CN 201611150260.2, filed Dec. 14, 2016, the entire contents thereof being incorporated herein by reference.

### FIELD

The present disclosure relates to covering parts in a vehicle, particularly to a carpet in a vehicle and a method of preparing the carpet.

### BACKGROUND

A vehicle typically includes various covering parts, such as a floor mat disposed on a vehicle floor, or a trunk carpet disposed in a trunk. The covering part generally contains several layers for improving its appearance and function. Conventionally the layers include non-woven fabric (NWF), polyethene (PE), polypropylene (PP), rubber, or felt, which are connected with adhesives. The adhesives commonly used in this area may contain volatile organic compounds (VOC), for example, aldehyde, toluene, benzene, etc. To eliminate the use of the VOC, U.S. Pat. No. 5,897,935A discloses a dash mat assembly for installation in a vehicle. The dash mat includes an acoustic barrier layer attached to an absorber layer. The inner surface of the acoustic barrier layer is in direct contact with the outer surface of the absorber layer. Fasteners are provided for attaching the layers together. Each fastener has an elongate pin with opposite ends and a flexible holding flange integrally molded at each end of the pin. The fasteners extend completely through the acoustic barrier layer and can extend either partially or completely through the absorber layer. A special insertion tool is used to insert the fasteners into the layers of the dash mat to connect the layers together. Thus, the dash mat assembly can have a high cost and the assembling process is complicated.

### SUMMARY

The present disclosure provides a carpet in a vehicle to at least address some of the issues described above. The carpet has a simple structure which results in better stability and aesthetic appearance. Further, the carpet is easy to be assembled, low in manufacturing cost, and convenient for maintenance and replacement.

According to one aspect of the present disclosure, a carpet in a vehicle is provided. The carpet includes a polypropylene (PP) layer; a felt layer; and at least one first fastener disposed between the PP layer and the felt layer. The first fastener has an upper half and a lower half inserted into a portion of the PP layer and a portion of the felt layer, respectively, to connect the PP layer and the felt layer.

In some embodiments, the felt layer includes at least one first recess recessed from a lower surface, and the upper half of the first fastener is retained in the first recess of the felt layer.

In some embodiments, the upper half of the first fastener includes an upper pillar and a plurality of upper connecting arms disposed on an outer surface of the upper pillar, and the upper pillar has a diameter less than that of the first recess. The upper connecting arms are deformable to allow the upper half of the first fastener to enter into the first recess, and return to a normal state to be rested on an inner wall of the first recess, such that the first fastener is connected with the felt layer.

In some embodiments, the upper pillar of the first fastener further includes a head having substantial cone shape.

In some embodiments, the PP layer includes at least one second recess recessed from an upper surface, and the lower half of the first fastener is retained in the second recess to be connected with the PP layer.

In some embodiments, the carpet includes a plurality of first fasteners, the felt layer includes a plurality of first recesses at the lower surface, and the PP layer includes a plurality of second recesses at the upper surface. Upper halves of the first fasteners are retained in the first recesses of the felt layer respectively, and lower halves of the first fasteners are retained in the second recesses of the PP layer respectively, such that the PP layer and the felt layer are connected.

In some embodiments, the lower half of the first fastener includes a lower pillar and a plurality of lower connecting arms disposed on an outer surface of the lower pillar, and the lower pillar has a diameter less than that of the second recess. The lower connecting arms are deformable to allow the lower half of the first fastener to enter into the second recess, and to return to a normal state to be rested on an inner wall of the second recess such that the first fastener is connected with the PP layer.

In some embodiments, the second recess of the PP layer includes a chamber and an opening communicated with the chamber. The opening has a diameter less than that of the chamber, the diameter of the chamber is greater than that of the first fastener, and the diameter of the opening is between that of the lower pillar and that of the first fastener. The lower connecting arms are configured to enter into the second recess via the opening and return to the normal state to be retained in the chamber.

In some embodiments, the lower half of the first fastener further includes a substantial cone-shaped base below the lower pillar.

In some embodiments the carpet further includes a non-woven fabric (NWF) layer disposed below the PP layer and at least one second fastener. The second fastener penetrates through the NWF layer and a portion of the PP layer to connect the NWF layer on a lower surface of the PP layer.

In some embodiments, the NWF layer includes at least one opening, and the PP layer includes at least one third recess recessed from the lower surface. The second fastener includes a base, a pillar connected on the base, and a plurality of connecting arms disposed at an outer surface of the pillar. The connecting arms are deformable to enter into the third recess via the opening in the NWF layer and return to a normal state to be retained in the third recess.

In some embodiments, the PP layer and the felt layer are connected by only the first fastener, and the PP layer and the NWF layer are connected by only the second fastener.

In some embodiments, the carpet further includes a cover layer disposed on the felt layer, and the cover layer contains a NWF layer and particles of polyethylene (PE) and styrene-butadiene rubber (SBR) dispersed in the NWF layer.

Another aspect of the present disclosure provides a method of preparing carpet in a vehicle. The method includes arranging at least one first fastener between a PP layer and a felt layer, and pressing the PP layer and the felt layer together. The felt layer includes at least one first recess recessed from a lower surface, the PP layer includes at least one second recess at an upper surface, and the first fastener includes an upper half and a lower half corresponding to the first recess and the second recess, respectively.

In some embodiments, the second recess has a depth less than a thickness of the PP layer, and the first recess has a depth less than a thickness of the felt layer.

In some embodiments, the PP layer and the felt layer are connected with only the first fastener.

In some embodiments, the method further includes connecting a non-woven fabric (NWF) layer on an outer surface of the PP layer with at least one second fasteners.

In some embodiments, the method further includes connecting a cover layer on an outer surface of the felt layer. The cover layer includes a NWF layer and PE and SBR particles dispersed in the NWF layer, and the PE and SBR particles move downwards between the felt layer and the PP layer during the pressing.

In some embodiments, the first fastener includes a pillar, a plurality of flexible upper connecting arms disposed at an outer surface of an upper half of the pillar, and a plurality of flexible lower connecting arms disposed at an outer surface of a lower half of the pillar. A diameter of the first recess is between diameters of the pillar and the upper half of the first fastener, and a diameter of the second recess is between diameters of the pillar and the lower half of the second fastener.

In some embodiments, the upper connecting arms are deformed to allow the upper half of the first fastener to enter into the first recess during assembling and return to a normal state thereafter such that the upper end of the first fastener is connected at the bottom of the felt layer.

In some embodiments, the lower connecting arms are deformed to allow the lower half of the first fastener to enter into the second recess during the assembling and return to a normal state thereafter such that the lower end of the first fastener is connected at the top of the PP layer.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

The above advantages and other advantages, and features of the present description will be readily apparent from the following detailed description when taken alone or in connection with the accompanying drawings.

### BRIEF DESCRIPTION OF THE DRAWINGS

FIG. 1 shows a carpet in a trunk of a vehicle, illustrating a carpet according to an embodiment of the present disclosure.

FIG. 2 is a cross-sectional view of the carpet in FIG. 1, illustrating a connection between layers of the carpet.

FIG. 3A is a partial enlarged view of a first fastener of the carpet in FIG. 2; and FIG. 3B is a top view of the first fastener.

FIG. 4 is a cross-sectional view of a carpet in a vehicle according to another embodiment of the present disclosure.

FIG. 5 is a flow chart for a method of preparing a carpet in a vehicle according to an embodiment of the present disclosure.

### DETAILED DESCRIPTION

Embodiments of the present disclosure are described herein. It is to be understood, however, that the disclosed embodiments are merely examples and other alternative embodiments can take various forms. The figures are not necessarily to be drawn in scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

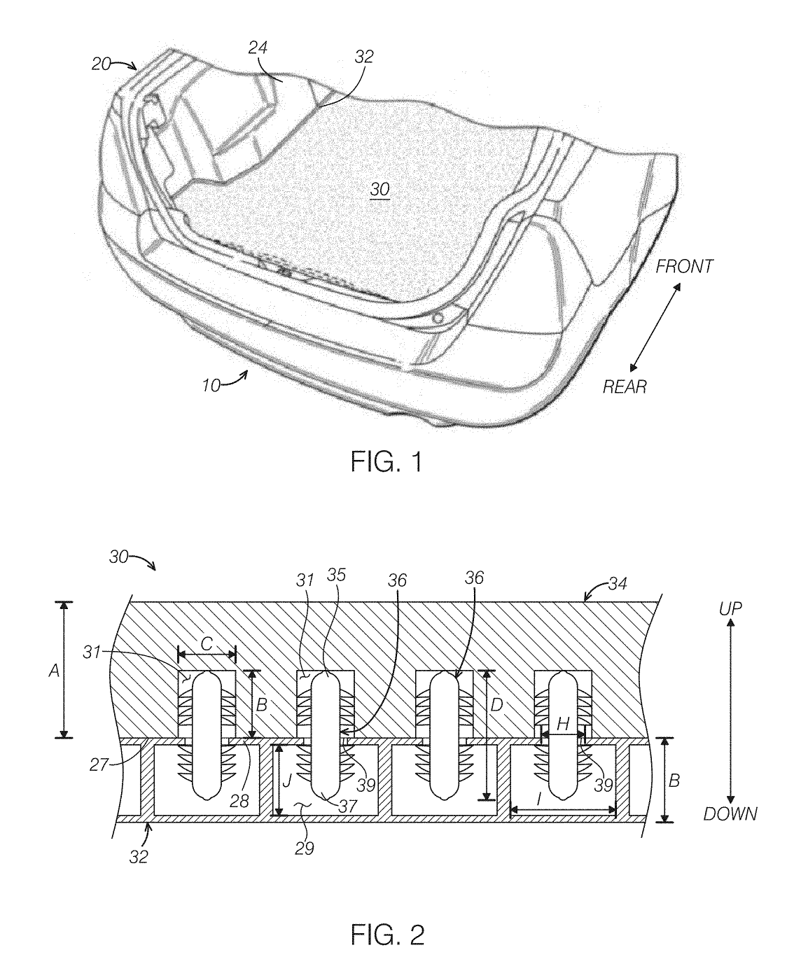

A vehicle typically includes various different carpets or mats to cover inner areas of the vehicle. FIG. 1 is a perspective view of a rear of a vehicle 10, illustrating a carpet 30 disposed in a trunk 20 of the vehicle 10. The trunk 20 is positioned at the rear of the vehicle 10, and the carpet 30 is disposed in the trunk 20 of vehicle. For the sake of illustration, the carpet 30 is depicted as being spread flat in the trunk 20, and the depicted state is also referred to as a normal state. In the state as shown in FIG. 1, the carpet 30 is disposed on an upper surface of sheet metal (not shown) in the trunk 20, covering the parts or tools in the trunk 20, such as a spare tire or a jack. Two lateral opposite sides 32 of the carpet 30 may extend slightly upwards to cover at least a part of two lateral sides of the trunk 20, which provides an aesthetic surface for users. The carpet 30 can prevent contaminants like dusts or vapors from corroding or damaging the sheet metal of the trunk 20, but also prevent cargo (not shown) in the trunk 20 from sliding.

It should be appreciated that, although the carpet 30 is shown as a trunk carpet in FIG. 1, the carpet in a vehicle according to embodiments of the present disclosure is not limited as a trunk carpet. In some embodiments, the carpet in a vehicle may be other covering parts in the vehicle, such as a floor mat or a floor carpet in the passenger compartment.

FIG. 2 is a cross-sectional view of the carpet 30. The carpet 30 may include a polypropylene (PP) layer 32, a felt layer 34, and at least one first fastener 36 to connect the PP layer 32 and the felt layer 34. As shown in FIG. 2, an upper end 35 and a lower end 37 of the first fastener 36 are retained in a portion of the felt layer 36 and a portion of the PP layer 34, respectively, such that the PP layer 36 and the felt layer 34 are connected to each other.

In the depicted embodiment, the upper end 35 of the first fastener 36 is inserted or enters into a first recess 31 formed in the felt layer 34 but does not pass through the entire thickness of the felt layer 34. Similarly, the lower end 37 of the first fastener 36 is inserted or enters into a second recess 29 formed into the PP layer 32 but does not pass through the entire thickness of the PP layer 32.

Although the carpet 30 is depicted to include four first fasteners 36 in FIG. 2, the number of the first fasteners 36 is not limited in the present disclosure. It should be appreciated that, the number of the first fastener 36 may be properly selected by those with ordinary skills in the art according to practical assembling requirements (such as an attaching strength of the first fastener 36, a surface area of the carpet 30), which should be construed as being included in the scope of the present disclosure.

In some embodiments, the felt layer 34 may be formed with fiber, and may be a needled mat or a needled felt. The felt layer 34 may have a thickness A in a range of about 5 mm to about 15 mm, such as in a range of about 8 mm to about 12 mm, preferably 10 mm. In some embodiments, as shown in FIG. 2, the felt layer 34 may have at least one first recess 31 recessed from a lower surface of 27 of the felt layer 34. The first recess 31 corresponds to an upper half 35 of the first fastener 36. The first recess 31 has a depth B in a range of about 2 mm to about 7 mm, such as a range of about 4 mm to about 6 mm, preferably 5 mm. The depth B is less than thickness A, such that the first fastener 36 can be retained in a portion of the felt layer 34 without penetrating through the entire thickness of the felt layer 34. The first recess 31 may have a width C in a range of about 2 mm to about 5 mm, such as a range of about 3 mm to about 4 mm. In some embodiments, the first recess 31 has a substantially cylindrical shape and a diameter of about 3 mm.

In some embodiments, one or more first recesses 31 are distributed in a lower surface of the felt layer 34. The number of the first recess 31 may be the same as the number of the first fastener 36, such as four as shown in FIG. 2, but it is not limited depicted embodiments in the present disclosure, those with ordinary skills in the art may select the number properly according to practical assembling requirements. In some embodiments, a plurality of first recesses 31 are distributed evenly in the lower surface of the felt layer 34 in a length or width direction of the felt layer 34, thus providing an even and robust attaching forces for the entire surface area of the carpet. With the felt layer 34, the carpet 30 can possess desired functions such as vibration dampening, better sealing, prevention from slippery, and resistance to wear. It should be appreciated that the felt layer 34 may be formed with similar materials, such as a rubber layer having the similar structure described above.

In some embodiments, the first fastener 36 has a height D in a range of about 6 mm to about 10 mm, such as about 7 mm to about 9 mm, preferably 8 mm. The first fastener 36 may be made from plastic, such as polyamide (PA), preferably PA66.

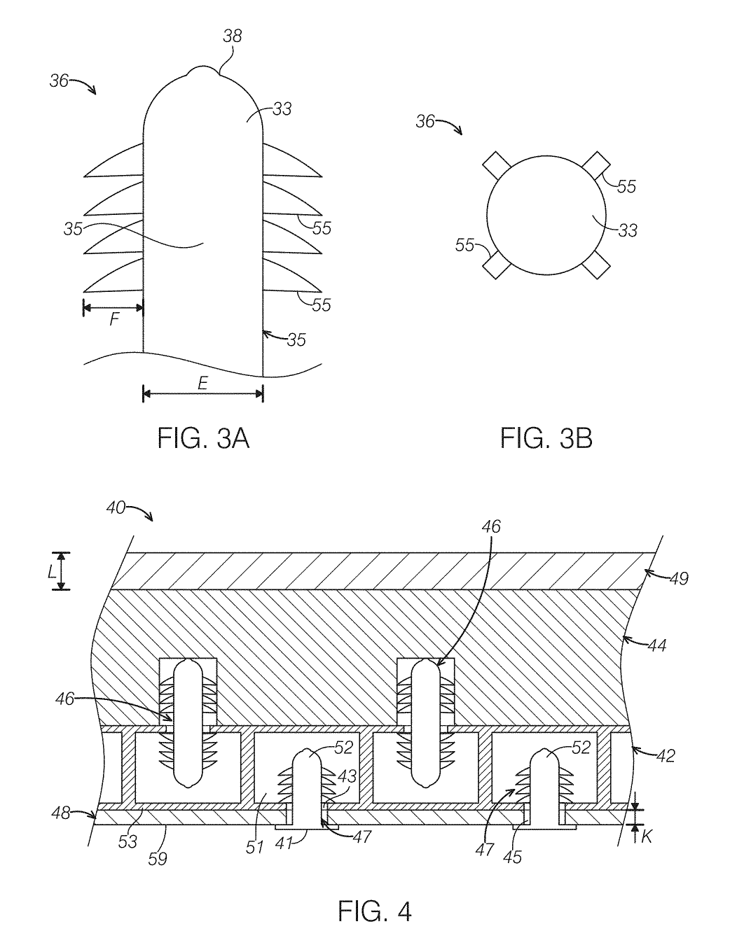

FIG. 3A is an enlarged view of a portion of the upper half 35 of the first fastener 36, and FIG. 3B is a top view of the first fastener 36. In some embodiments, as shown in FIGS. 3A and 3B, the upper half 35 includes an upper pillar 33 and a plurality of upper connecting arms 55 disposed on an outer surface of the upper pillar 33. A width of diameter E of the upper pillar 33 may be in a range of about 1 mm to about 4 mm, such as 3 mm. Each of the upper connecting arms 55 may have a length F at a direction substantially perpendicular to the upper pillar 33. The length F may be in a range of about 0.5 mm to about 2 mm, alternatively about 0.8 mm to about 1.5 mm, preferably 1 mm. In some embodiments, the upper connecting arms 55 are arranged as several columns in an up-down direction and are spaced apart evenly at a circumference of the upper pillar 33. In the depicted embodiment, the upper pillar 33 has a substantially cylindrical shape, and the upper connecting arms 55 are arranged as four columns spaced evenly at the perimeter of the upper pillar 33. In some embodiments, each of upper connecting arms 55 may have a sharp tip.

The upper connecting arms 55 may have relatively larger stiffness. Referring to FIGS. 2 and 3A, during assembling, the first recess 31 of the felt layer 34 slightly deforms to allow the upper half 35 of the first fastener 36 to pass through, and then the upper connecting arms 55 are supported or rest on an inner wall of the first recess 31, such that the first fastener 36 is connected to the felt layer 34.

In some embodiments, the upper connecting arms 55 are flexible, i.e., deformable. During assembling, the upper connecting arms 55 are deformed such that the first upper half 35 of the first fasteners 36 can enter into the first recesses 31, and then return to the normal state to rest or be supported on an inner wall of the first recesses 31. The length F of each of the upper connecting arms 55 may be greater than a half of a difference between the width C of the first recesses 31 and the diameter E of the upper pillar 33, e.g. F>(C−E)/2. In this way, the upper connecting arms 55 may be in a compressed state when being retained in the first recesses 31, thus enhancing the connection between the felt layer 34 and the first fasteners 36.

In some embodiments, the upper connecting arms 55 extend laterally and slightly downwards. In this way, once the first fasteners 36 are retained in the felt layer 34, the upper connecting arms 55 rest on the inner wall of the first recesses 31 like barbs, which provides a more robust connection between the felt layer 34 and the first fasteners 36 to prevent the felt layer 34 from release from the carpet 30.

In some embodiments, as shown in FIG. 3A, the upper half 35 of the first fastener 36 includes a substantially conical head 38. During an assembling between the first fasteners 36 and the felt layer 34, an inclined guiding surface of the conical head 38 may facilitate an insertion of the upper half 35 into the first recesses 31, and a tip of the conical head 38 may contact or penetrate a top wall of the first recesses 31. In this way, the connection between the first fasteners 36 and the felt layer 34 is further enhanced.

In should be appreciated that, the lower half 37 of each of the first fasteners 36 may be symmetrical to the upper half 35 relative to a middle line in a direction perpendicular to the pillar 33. For the sake of brevity, structure, materials, and operation functions of the lower half 37 may refer to the description associated with the upper half 35, and will not be described in detail. In some embodiments, the upper and lower halves 35, 37 of the first fastener 36 are retained in a portion of the felt layer 34 (e.g., the first recesses 31) and a portion of the PP layer 32 (e.g., the second recesses 29), such that the felt layer 34 and the PP layer 32 are connected to each other.

Turning to FIG. 2, in some embodiments, as shown in FIG. 2, the PP layer 32 may have a thickness G in a range of about 3 mm to about 8 mm, alternatively about 4 mm to about 6 mm, preferably about 5 mm. The PP layer includes at least one second recess 29 recessed from an upper surface 28. The second recess 33 has an opening 39 at the upper surface 28. During the assembling, the lower half 37 of the first fastener 36 enters into the the second recesses 29 via the opening 39 and then retained in the second recess 29. A width or diameter H of the opening 39 is greater than a width or a diameter of a lower pillar of the lower half 37. The width or the diameter of the lower pillar may be equal to the width or diameter E of the upper pillar. In one example, the diameter H of the opening 39 may be in a range of about 3 mm to about 6 mm, alternatively in a range of about 4 mm to about 5 mm.

In some embodiments, as shown in FIG. 2, the second recess 29 may have a width or diameter I greater than the diameter H. In those embodiments, during assembling of the first fasteners 36 to the PP layer 32, the lower connecting arms of the lower half 37 of the first fastener 36 are deformed to allow the lower half 37 to enter into the second recess 29, and the connecting arms are returned to the normal state after received in the second recess 29. As the width of the lower half 37 (e.g., a total of the width E and two lengths F) is greater than the diameter H of the opening 39, the lower end 37 can be retained in the second recess 29. In this way, the first fastener 36 is robustly connected on the PP layer 32.

In some embodiments, the second recess 29 has a width or diameter I equal to the diameter H of the opening 39. In those embodiments, once the first fastener 36 is connected on the PP layer 32, the lower connecting arms of the lower half 37 is deformed to allow the lower half 37 to enter the second recess 29, and then the lower connecting arms are returned to the normal state and supported on the inner wall of the second recess 29. In this condition, the lower connecting arms are still in a compressed state and rest against the inner wall of the second recess 29, thus the connection strength between the first fasteners 36 and the PP layer 32 can be enhanced.

In some embodiments, the second recess 29 has a depth J less than a thickness G of the PP layer 32. For example, the depth J may be in a range of about 3 mm to about 7 mm, preferably 5 mm. In this way, the lower half 37 of the first fastener 36 may be inserted in a portion of the PP layer 32 (such as being retained within the second recess 29) without penetrating through the entire thickness G of the PP layer 32.

Additional features of the lower half 37 of the first fasteners 36 as well as the connection between the lower half 37 and the second recess 29 of the PP layer may refer to the description above associated with the upper half 35, and thus will not be described in detail.

In some embodiments, the PP layer 32 may be formed with PP twin board with a plurality of lateral chambers extending through its length, the opening 39 is communicated with the chambers, thus defining a plurality of second recesses 29 for retaining the lower half 37 of the first fastener 36. With the PP layer 32 according to the embodiments of the present disclosure, the carpet 30 has relative stiffness which provides enhanced wear resistance. In addition, using PP twin board as the PP layer 32 may ensure the stiffness of the carpet 30 while reduce the manufacturing cost.

According to embodiments of the present disclosure, the PP layer and felt layer of the carpet may be connected or attached via only the first fastener without using any volatile organic compound (VOC) as adhesives. In addition, at least one first fastener can be retained in various different positions between the PP layer and the felt layer, which provides continuous and flat outer surfaces for the PP layer and the felt layer, respectively, thus facilitating a further connection between the PP layer and other layer or a further connection between the felt layer and other layer. In some embodiments, the PP layer or the felt layer is the outer layer (e.g. no additional cover layer on the felt layer or base layer below the PP layer), and the continuous surfaces of the felt layer and PP layer can provide an aesthetic appearance.

FIG. 4 is a cross-sectional view of a carpet 40 in a vehicle according to another embodiment of the present disclosure. The carpet 40 includes a PP layer 42, a felt layer 44, and a plurality of first fasteners 46 between the PP layer 42 and the felt layer 44 to connect or attach the PP layer and the felt layer 44. The structure of the PP layer 42, the felt layer 44, and the first fasteners 46 are substantially similar to the PP layer 32, the felt layer 34, and the first fasteners 36 of the carpet 30 described above, which will not be described in detail.

In some embodiments, the carpet 40 further includes a non-woven fabric (NWF) layer 48 attached below the PP layer via at least one second fastener 47. In some embodiments, the NWF layer 48 has at least one through hole 45, a lower surface 53 of the PP layer 42 includes at least one opening 43 communicated with a chamber 51 of the PP layer 42. The second fastener 47 passes through the through hole 45 and the corresponding opening 43 in turn to connect the NWF layer 48 on the lower surface 53 of the PP layer 42. The chamber 51 may be formed in the PP layer 42 and communicated with the opening 43. The chamber 51 is similar to the second recess 29 described above associated with FIG. 2.

In some embodiments, the chamber 51 may be communicated with a first recess in the PP layer 44. That is, one chamber 51 receives both a lower half of the first fastener and an upper half of the second fastener 47. In some embodiments, the NWF layer 48 has a thickness K in a range of about 1 mm to about 3 mm, such as about 1.5 mm. Additional features of the through hole 45 and opening 43 may refer to descriptions of the opening 39 of the PP layer 32, thus will not be described in detail.

In some embodiments, the second fastener 47 may have a base panel 41 and an upper half 52 disposed on an upper surface of the base panel 41. The base panel 41 has a width or a diameter larger than that of the through hole 45 or the opening 43. The features of the upper half 52 are similar to the upper half 35 of the first fastener 36 described in FIGS. 3A and 3B. In some embodiments, during assembling of the NWF layer 48 to the PP layer 42 via the second fastener 47, the upper half 52 of the second fastener 47 passes through the through hole 45 and the opening 43 in sequence and are retained in the chamber 51 of the PP layer 42. The base panel 41 rests against the bottom surface 59 of the NWF layer 48, thus attaching the NWF layer 48 on the bottom surface 59 of the PP layer 42 tightly. The NWF layer 48 is disposed between the PP layer 42 and the sheet metal in the trunk to avoid wear of the sheet metal and to improve vibration damping effect of the carpet.

In some embodiments, as shown in FIG. 4, the carpet 40 further includes a cover layer 49 on the felt layer 44. The cover layer 49 may include a NWF layer and some organic adhesives dispersed in the NWF layer, such as polyethylene (PE) particles and/or styrene-butadiene rubber (SBR) particles. During manufacturing of the carpet 40, a hot pressing of sublayers causes these adhesive particles in the cover layer 49 to move downwards between the cover layer 49 and the felt layer 44, or even inside the felt layer 44, thus attaching the cover layer 49 to the felt layer 44 tightly. The cover layer 49 may have a thickness L in a range of about 1 mm to 5 mm, alternatively about 2 mm to about 4 mm, preferably 3 mm. According to the embodiments of the present disclosure, the cover layer 49 may be attached on the felt layer 44 via self-contained adhesive particles which are friendly to human health, and further provide the carpet 44 with enhanced slide resistance, shock dampening, wear resistance, and aesthetic appearance.

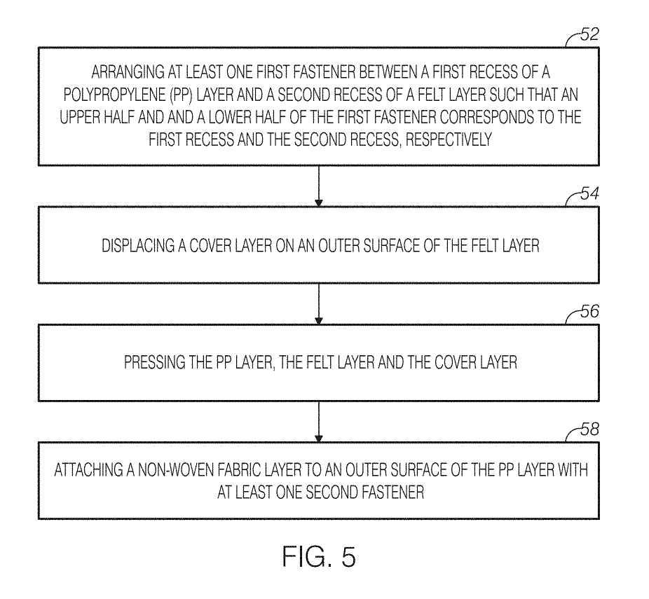

FIG. 5 is a flow chart of a method 50 of preparing a carpet in a vehicle. The method 50 at 52, includes arranging at least one first fastener between a first recess of a PP layer and a second recess of a felt layer such that an upper half and a lower half of the first fastener correspond to the first recess and the second recess, respectively.

In some embodiments, arranging at least one first fastener between the first recess of a PP layer and the second recess of a felt layer includes positioning the entire lower half of the first fastener into the second recess. In another embodiment, arranging at least one first fasteners between the first recess of a PP layer and the second recess of a felt layer includes placing the lower half of the first fastener just on a top of the second recess. In yet another embodiment, arranging at least one first fastener between the first recess of a PP layer and the second recess of a felt layer includes placing the lower half of the first fastener above the second recess without any contact therebetween. The method 50 arranges the upper half of the first fastener similarly.

In some embodiments, the second recess in the PP layer may face upwards and has a depth less than a thickness of the PP layer. In some embodiments, the PP layer includes a plurality of second recesses which are distributed evenly in an upper surface of the PP layer. A process of forming recesses in the PP layer is known to those with ordinary skills in the art, such as operating with a numeric control drill, and will not be described in detail.

In some embodiments, the felt layer includes a plurality of first recesses. The first recesses in the felt layer may face downwards, and each of the first recesses has a depth less than a thickness of the felt layer. In some embodiments, the first recesses are distributed evenly in a lower surface of the felt layer and correspond to the second recesses in the PP layer. A process of forming recesses in the felt layer is known to those with ordinary skills in the art, such as operating with a numeric control drill or moulding, and will not be described

In some embodiments, the step 52 includes providing a felt layer having a plurality of first recesses on a upper surface; placing a plurality of first fasteners on the surface of the felt layer such that one end of each of the first fasteners corresponds to one of the first recesses of the felt layer; and placing a PP layer having a plurality of second recesses on the felt layer such that an opposite end of each of the first fasteners is corresponding to one of the second recesses in the PP layer. As the stiffness of the PP layer is larger than that of the felt layer and the following steps include pressing, it is preferred to place the PP layer above the felt layer at a pressing direction. The pressing direction is parallel to the thickness direction of the carpet.

In some embodiments, the sequence for placing the felt layer and the PP layer on a work station may be different. For example, the method 50 may include providing the PP layer first, then placing the first fasteners, and finally providing the felt layer. As the stiffness of the PP layer is larger than that of the felt layer, the step 52 may include turning the initially connected PP layer and the felt layer over such that the PP layer locates above the felt layer during the pressing. That is, the step 52 includes providing a PP layer having a plurality of second recesses on a surface; distributing a plurality of first fasteners on the surface of the PP layer such that one end of each of the first fasteners corresponds to one of the second recesses of the PP layer; providing a felt layer having a plurality of first recesses on the PP layer such that an opposite end of each of the first fasteners is corresponding to one of the first recesses in the felt layer, thus forming a combined layer including the PP layer and the felt layer; turning over the combined layer such that the PP layer is positioned above the felt layer.

In some embodiments, the method 50 further includes displacing a cover layer on an outer surface of the felt layer at 54. The outer surface of the felt layer may mean a surface of the felt layer opposite to a surface facing the PP layer.

At step 56, pressing the layers, such as a combination of the PP layer, the felt layer, and the cover layer. The upper half and the lower half of each of the first fasteners pass through a portion of the felt layer e.g., being retained in one of the first recesses) and a portion of the PP layer (e.g., being retained in one of the second recesses), respectively, to attach the two layers tightly.

The first fasteners are disposed between the lower surface of the felt layer and the upper surface of the PP layer, such that a combination of the felt layer and the PP layer has flat outer surfaces (e.g., the upper surface of the felt layer and the lower surface of the PP layer). In this way, all connection points formed by the first fasteners may not show at the outer surface of the carpet, thus the outer surface has aesthetic appearance and further is easy to form connection with additional layers.

In some embodiments, the cover layer includes a NWF layer and particles of PE and SBR dispersed in the NWF layer. During the step 56, PE and SBR particles as organic adhesives will move downwards from the cover layer to the felt layer and even between the felt layer and the PP layer, thus the connection between the cover layer and the felt layer and even the connection between the felt layer and the PP layer can be enhanced.

The pressing may include heat treatments, such as using hot pressing. Hot pressing may cause the layers to be thinner to attach with each other tightly. It should be appreciated that, hot pressing is known to those skills in the art and related operation and parameters can be set with practical preparing requirements, and will not be described in detail.

In some embodiments, the method 50 further includes, at step 58, attaching a NWF layer to an outer surface of the PP layer via at least one second fastener. The PP layer has at least one third recesses in the outer surface (e.g., a lower surface), and the NWF layer has at least one openings. The step 58 may include: placing the NWF layer on the PP layer such that the openings in the NWF layer corresponds to the third recesses in the PP layer; distributing at least one second fasteners on the NWF layer such that the second fastener is corresponding to the opening in the NWF layer; and pressing the layers together with the second fastener such that the second fastener has a portion penetrating into the opening and the third recess to attach the NWF layer on the PP layer. Forming openings in a NWF layer is known to those with ordinary skills in the art. For example, a numerical control drill, a moulding, or cutting by water injection may be used, which will not be described in detail.

It should be appreciated that steps 54 and 58 in the method 50 are optional and not required. In some embodiments, the method 50 does not include step 54, and the combined layer being pressed in step 56 includes only the PP layer and the felt layer. In some embodiments, the method 50 does not include step 58, e.g., no NWF layer is attached at the bottom of the PP layer. In addition, there is no special limit to the operation sequence of the steps in the method of the present disclosure, those with ordinary skills in the art may change the sequence of the steps according to practical requirements, which should be construed as being included in the scope of the present disclosure.

The carpet in a vehicle according to embodiments of the present disclosure may not contain any VOC adhesives and thus environment friendly. The fasteners for connecting a PP layer and a felt layer are disposed between these two layers and are unnoticeable from a viewing surface, thus providing aesthetic appearance. Further, the recesses in the layers may be formed using conventional processes in a assembly line, thus the total cost for manufacturing the carpet assembling can be reduced.

The carpet of the present disclosure may be used in a passenger vehicle, a commercial vehicle, or various other vehicles, such as agriculture machines, transportation ships, or airplanes. Those applications should be considered as included in the scope of term “vehicle” cited in this disclosure.

It should be appreciated that the embodiments described above are specific examples that do not encompass all possible forms of the disclosure. The features of the illustrated embodiments may be combined to form additional or alternative embodiments of the disclosed concepts. The words used in the specification are words of description rather than limitation, and it is understood that changes can be made without departing from the spirit and scope of the disclosure. The scope of the following claims is broader than the specifically disclosed embodiments and includes modifications of the illustrated embodiments.

1. A carpet in a vehicle, comprising:
a polypropylene (PP) layer;
a felt layer; and
at least one first fastener disposed between the PP layer and the felt layer, wherein the first fastener has an upper half and a lower half inserted into a portion of the PP layer and a portion of the felt layer, respectively, to connect the PP layer and the felt layer.

2. The carpet of claim 1, wherein the felt layer includes at least one first recess recessed from a lower surface, and the upper half of the first fastener is retained in the first recess of the felt layer.

3. The carpet of claim 2, wherein the upper half of the first fastener includes an upper pillar and a plurality of upper connecting arms disposed on an outer surface of the upper pillar, the upper pillar has a diameter less than that of the first recess; and the upper connecting arms are deformable to allow the upper half of the first fastener to enter into the first recess, and return to a normal state to be rested on an inner wall of the first recess, such that the first fastener is connected with the felt layer.

4. The carpet of claim 3, wherein the upper pillar of the first fastener further includes a head having substantial cone shape.

5. The carpet of claim 1, wherein the PP layer includes at least one second recess recessed from an upper surface, the lower half of the first fastener is retained in the second recess to be connected with the PP layer.

6. The carpet of claim 5, wherein the lower half of the first fastener includes a lower pillar and a plurality of lower connecting arms disposed on an outer surface of the lower pillar, the lower pillar has a diameter less than that of the second recess; and the lower connecting arms are deformable to allow the lower half of the first fastener to enter into the second recess, and to return to a normal state to be rested on an inner wall of the second recess such that the first fastener is connected with the PP layer.

7. The carpet of claim 1, wherein the second recess of the PP layer includes a chamber and an opening communicated with the chamber, wherein the opening has a diameter less than that of the chamber, the diameter of the chamber is greater than that of the first fastener, the diameter of the opening is between that of the lower pillar and that of the first fastener, and the lower connecting arms are configured to enter into the second recess via the opening and return to the normal state to be retained in the chamber.

8. The carpet of claim 7, wherein the lower half of the first fastener further includes a substantial cone-shaped base below the lower pillar.

9. The carpet of claim 1, further comprising a non-woven fabric (NWF) layer disposed below the PP layer and at least one second fastener, wherein the second fastener penetrates through the NWF layer and a portion of the PP layer to connect the NWF layer on a lower surface of the PP layer.

10. The carpet of claim 9, wherein the NWF layer comprises at least one openings thereon, the PP layer includes at least one third recess recessed from the lower surface, the second fastener includes a base, a pillar connected on the base, and a plurality of connecting arms disposed at an outer surface of the pillar, wherein the connecting arms are deformable to enter into the third recess via the opening in the NWF layer and return to a normal state to be retained in the third recess.

11. The carpet of claim 10, wherein the PP layer and the felt layer are connected by only the first fastener, and the PP layer and the NWF layer are connected by only the second fastener.

12. The carpet of claim 1, further comprising a cover layer disposed on the felt layer, and the cover layer contains a NWF layer and particles of polyethylene (PE) and styrene-butadiene rubber (SBR) dispersed in the NWF layer.

13. A method of preparing carpet in a vehicle, comprising:
arranging at least one first fastener between a PP layer and a felt layer, wherein the felt layer includes at least one first recess recessed from a lower surface, the PP layer includes at least one second recess at an upper surface, and the first fastener includes an upper half and a lower half corresponding to the first recess and the second recess, respectively; and
pressing the PP layer and the felt layer together.

14. The method of claim 13, wherein the second recess has a depth less than a thickness of the PP layer, and the first recess has a depth less than a thickness of the felt layer.

15. The method of claim 15, wherein the PP layer and the felt layer are connected with only the first fastener.

16. The method of claim 13, further comprising: connecting a non-woven fabric (NWF) layer on an outer surface of the PP layer with at least one second fasteners.

17. The method of claim 13, further comprising: connecting a cover layer on an outer surface of the felt layer, wherein the cover layer includes a NWF layer and PE and SBR particles dispersed in the NWF layer, and the PE and SBR particles move downwards between the felt layer and the PP layer during the pressing.

18. The method of claim 11, wherein the first fastener comprises a pillar, a plurality of flexible upper connecting arms disposed at an outer surface of an upper half of the pillar, and a plurality of flexible lower connecting arms disposed at an outer surface of a lower half of the pillar; and a diameter of the first recess is between diameters of the pillar and the upper half of the first fastener, and a diameter of the second recess is between diameters of the pillar and the lower half of the second fastener.

19. The method of claim 13, wherein the upper connecting arms are deformed to allow the upper half of the first fastener to enter into the first recess during assembling and return to a normal state thereafter such that the upper end of the first fastener is connected at the bottom of the felt layer.

20. The method of claim 13, wherein the lower connecting arms are deformed to allow the lower half of the first fastener to enter into the second recess during the assembling and return to a normal state thereafter such that the lower end of the first fastener is connected at the top of the PP layer.
